(19) United States
(12) Patent Application Publication
(10) Pub. No.: US 2009/0287568 A1
(43) Pub. Date: Nov. 19, 2009

(54) Method for providing daily dynamic visual information on beverage sleeves and/or cups

(76) Inventor: Eftim Cesmedziev, San Pedro, CA (US)

Correspondence Address: Eftim Cesmedziev, 326 S. Miraleste Drive 198, San Pedro, CA, 90732, US

(21) Appl. No.: 12/152,819

(22) Filed: May 16, 2008

(51) Int. Cl. G06Q 30/00; G06Q 90/00

(52) U.S. Cl. 705/14.53

(57) ABSTRACT

The present invention relates generally to method where advertising content may contain daily up to date information printed on the sleeves and/or cups or labels, such as daily national and world wide news, daily local weather report, daily comics, jokes, daily business and stock market information, daily local news, daily emergency local news, sport news, lottery report, health and sport information, and other daily information for the customers, advertising, sales, and the like.

### RELATED APPLICATION

Not applicable.

### CROSS-REFERENCE TO RELATED APPLICATION

Not applicable.

### STATEMENT REGARDING STATE SPONSORED RESEARCH OR DEVELOPMENT

Not applicable

### TECHNICAL FIELD

The present invention relates generally to method for providing advertising content on beverage insulating sleeves and cups, more particularly, to creating a method where advertising content may contain up to date information printed on the outer side of the sleeves and/or cups, such as daily national and world wide news, daily local weather report, daily comics, jokes, daily business and stock market information, daily local news, daily emergency local news, sport news, lottery report, health and sport information, and other daily information for the customers, advertising, sales, and the like.

### BACKGROUND OF THE INVENTION

Hot and cold beverages have been sold in various food and drink venues, such as fast food restaurants, coffee shops, internet café, hospitals, businesses, hotels, etc. People invented thermal insulating sleeves for holding beverage containers, that provide protection against discomfort or burning that can occur when person holds beverage sleeves that is attached to the outer side of the beverage container, which is too hot or too cold due to the temperature off the liquid inside the beverage container. Outer side of the sleeves is used for printing visual information that is used for advertising. Usually, printed information is made from logo of the company and the message that the company want to advertise. In this way, company advertise it self or the desired event.

However, in the prior art, the visual information that is printed on the outer side of the beverage insulating sleeves and/or the cups, is not corresponding with same speed as the speed of today's dynamic life. Because of that, daily news information is not printed on the outer side of the beverage sleeves and/or cups. Visual information placed on the outer side of the beverage sleeves and/or cups need to correlate with the changes in the people's life. That is the essence of this invention. Using this invention, all visual information may be up to date with the reality and give daily information to the customers. In this way, beverage sleeves and/or cups become very informational. News that happened previous day may be printed on the beverage sleeves and/or cups, so people can get the information from previous day first things in the morning. In addition, report from the stock market from the previous day may be printed together with jokes, lottery report, advertising, health information, emergencies, and the like.

There are different printing techniques to print daily advertisement on the sleeves and/or cups, such as offset printing, stamping stamps and/or screen-printing. Another way to do that is to print labels using same techniques, such as offset printing, stamping stamps, computer printing and/or screen-printing, where customer may choose the desired design and glued on the outer side of the beverage sleeves and/or cups. The designs may be find, chosen and downloaded from the internet and web sites, or send by an e-mail, or other electronic way of delivery information.

### BRIEF SUMMARY OF THE INVENTION

The general purpose of the present invention, which will be described subsequently in detail later, is to provide method for placing advertising content on the outer side of the beverage sleeves and/or cups that contain collecting daily un to date information that correlates with the speed and needs of today's daily life, heretofore as a prior art and novel features that which is not anticipated, rendered obvious, suggested, or even implied by any of the prior art, either alone or in any combination thereof.

Moreover, one embodiment of the present invention includes design with advertising content that provide daily information printed on the outer side of the beverage sleeves and/or cups. That information may include daily local weather report, daily comics, jokes, daily business and stock market information, daily local news, daily emergency local news, sport news, lottery report, health and sport information, and other daily information for the customers, warnings, emergency information, advertising, sales, and the like. All this information may be used to reach more people and direct them to the companies that pays for advertising. Companies have chance to reach people daily, same people repeatedly, constantly reminding them about their products. The design with or without advertising content, may be a photo design, graphic design, number or numbers, letter or letters, color or colors, sign or signs, logo or logos, phone number or phone numbers, address or addresses, web site address or web site addresses, e-mail address or e-mail addresses, and/or combination of them. This designed advertising content need to be clear and understandable to attract attention of the public. The designed advertising content may also include information from company that advertises its product(s) together with the daily information offered to the beverage customers.

Another embodiment of the present invention includes daily collecting information and selecting them according the needs of the customers. Internet and websites, newspapers, TV, radio, magazines and other legal sources may be used for collecting information. Offering survey(s) with relevant questions to the customers may help to know what kind of information they are interested to read. Customer's zip code or phone number may do selecting adequate information for them. Designed information may be print daily, anytime of the day or night according the needs, using an offset print techniques, stamping stamps and/or screen printing techniques, or any other method of printing already known in printing industry. If there is a situation where beverage sleeves and/or cup are already printed with old information and they are not compatible with the new situation, then labels with new printed information on them may be used and they may be placed over the old information. In that way, leftovers of the beverage sleeves and/or cups with old information will be eliminated.

Another embodiment of the present invention includes daily delivery of the printed beverage sleeves and/or cups to the customers that order them. After printing is done on the beverage sleeves and/or cups, they are prepared for shipping to the customers. Deliveries of the sleeves and/or cups may be done hourly, daily, weekly and/or on monthly routines. Deliveries of the beverage sleeves and/or cups are done in a ways that are already known in the prior art of delivery industry.

Another embodiment of the present invention includes manufacturing company that manufactures beverage sleeves and/or cups that covers certain territory with its products. That territory may be a city, county, state and the like. In addition, a design company covers same territory, where person(s) and/or company or companies collect information and create design for the beverage sleeves and/or cups based on that information. They may have a business agreement(s) with people(s) and/or company or companies that will print the created design on the outer side of beverage sleeves and/or cups and deliver them to the final customers. Design company may also print the design on the outer side of beverage sleeves and/or cups, as well manufacturing company, if they have a hardware and software adequate for that. Printing and delivery company may be located locally, in order to deliver the products faster and information printed on the beverage sleeves and/or cups are more accurate.

In this respect, before explaining at least one embodiment of the invention in greater detail, it is to understand that invention is not limited in its application to the details and steps of construction and to arrangements of the components/steps set forth in the following description. The invention is capable of other embodiments and of being practiced and carried out in various ways. In addition, it is to be understood that the phraseology and terminology employed herein is for the purpose of description and should not be regarded as limiting.

As such, those skilled in the art will appreciate that the conceptions, upon which this disclosure is based, may readily be utilized as a basis for the designing of other structures, devices, methods and system for carrying out the several purposes of the present invention. It is important, therefore, that the claims be regarded as including such equivalent constructions insofar as they do not depart from the spirit and scope of the present invention.

Further, the purpose of the foregoing abstract is to enable the Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application not is it intended to be limiting as to the scope of the invention in any way.

### DETAILED DESCRIPTION OF THE PREFERRED EMBODIMENTS

Aspects of the invention may be practiced using any suitable arrangement of the elements of the invention. However, it should be understood that these illustrative embodiments of the invention should not be used to narrowly interpret the scope of the invention.

Coffee cup that has beverage-insulating sleeve on it, become one of the first contacts for that particular day that customer has it. That contact may be used to reach people and direct them to the companies that advertise its products. One study finds that every coffee drinker spends around 40 minutes with same cup of coffee. That is tame that can be used for quality advertising. That is main reason why this method is created.

One embodiment of this invention is represented with several components connected adequately and functionally together as a one successfully working unit. The components of the embodiment of the invention are: company that manufacturers beverage sleeves and/or cups (“manufacturing company”), person(s) and/or company or companies that created design(s) (“design company”), daily collection of information collected by person(s) and/or company or companies, person(s) and/or company or companies that print the design on a beverage sleeves and/or cups (“printing company”), person and/or company or companies that deliver the printed beverage sleeves and cups to the customers (“delivery company”). There may be more components of the embodiments of the invention and/or various modifications of the elements of the embodiments, without deviating from the spirit and scope of the invention.

In general terms, the invention has a few steps that are connected together adequately and functionally, where:

manufacturing company that produces beverage sleeves and/or cups covers a certain territory with its products, such as city, province, county, state and the like.

within that territory may be created a design company or person that does designs. The design company may collect information from that territory, using any known method for that and create a design based on that information. The design company may also do print on the beverage sleeves and/or cups and/or labels using any available adequately and functionally connected together hardware and software, or send the design to the printing company and/or person(s) who will do the print job, using any known technology, hardware and software in order the print company and/or person to receive the created design.

print company and/or person(s) may be chosen by the location of the customers, by the customer's zip code, by their phone number and/or address or by any other way. The print company may use any known technique of printing known in the printing industry, including, but not limited to, offset printing, screen-printing, stamping stamps and the like.

printed beverage sleeves and/or cups may be delivered to its customers by a delivery company or companies and/or person(s), or by any other person(s) and/or company or companies.

this steps may be repeated and/or may be modified for better services.

all this steps are regulated by a business contract, where all situations are covered as is known in the business industry.

One of the elements of the embodiment includes company or companies that manufacture beverage sleeves and/or cups. The manufacturing company may also collect daily information that needs to be print, or not. After manufacturing the beverage sleeves and/or cups, the manufacturing company sends the sleeves and/or cups to the printing company or companies and/or person(s) who do printing, in an already well-known way of delivering goods, known in the delivery industry. Collected daily information may be design by a separate department of the manufacturing company that use those information for creating the design, or those information are send to the design company for creating the design. There is an option that manufacturing company produce, print and deliver printed beverage sleeves and/or cups to its final customers.

The same embodiment also includes daily collection of information collected from different sources and creating design for the beverage sleeves and/or cups based on that information. This may be done by a company that manufacturers beverage sleeves and/or cups, or by any person(s) and/or company or companies who do that. Collecting information according the customer's need may be collected on daily basis, selecting and choosing them according the needs of the customers. Internet and websites, newspapers, TV, radio, magazines and other legal sources may be used for collecting needed information. There may be a business contract signed with some source of information to provide daily information for design company. Offering survey(s) with relevant questions to the customers may help to know what kind of information they are interested to read. Customer's zip code or phone number(s) may do selecting and choosing adequate information for them. After collecting, choosing and selecting the needed information, person, company and/or design company may used it to create the desired design using adequately and functionally connected successfully working computer(s), which are an adequately and functionally together connected hardware and software in a way already known in a graphic design industry. Design may include, but not limited to, daily local weather report, daily comics, jokes, daily business and stock market information, daily local news, daily sport news, lottery report, health and sport information, warnings, emergency information, advertising, sales, and the like, photo or photos, graphics, number or numbers, letter or letters, color or colors, sign or signs, symbol or symbols, logo or logos, phone number or phone numbers, address or addresses, web site address or web site addresses, e-mail address or e-mail addresses, any language and/or any combination of them.

Manufacturing company and the design company as elements of embodiment of the invention may be part of a same business network or not. They may have a business relation with a local print shop or not, where they send the design to be printed on beverage sleeves and/or cups using well-known methods and techniques known in printing industry. The design from the design company or from company may be send to the print shop using any delivery method, including, but not limited to, using internet and websites for sending adequately and functionally e-mail(s) to desired e-mail address or e-mail addresses, and/or regular mail, using fax, “Skype” program and/or other computer programs, hardware and software and/or any other way known in the prior art of delivering information.

Printing of the desired design on the outer side of the beverage sleeves and/or cups as an element of the embodiment is done by a person(s) and/or company or companies that prints the design on a beverage sleeves and/or cups (“printing company”). The printing company may be a person(s) and/or company or companies that are located locally to the customers, and/or a national print network. The design may be print daily, anytime of the day or night according the needs using, including but not limited to, an offset print techniques, stamping stamp and/or screen printing techniques, or any other method of printing and stamping known in printing industry. When beverage sleeves and/or cups are already printed with old information and they are not compatible with the new situation, then labels with new printed information on them may be used and they may be placed over the old information. In that way, leftovers of the beverage sleeves and/or cups with old information will be eliminated.

The same embodiment also includes daily delivery of the printed beverage sleeves and/or cups to the customers that order them, by person(s) and/or by a delivering company or companies (“delivering company”). From the print shop, the beverage sleeves and/or cups and/or labels are prepared for shipping to the customers. Deliveries of the sleeves and/or cups and/or labels may be done hourly, daily, weekly, on monthly routines and the like. Deliveries are done in a ways that are already known in the delivery industry.

Labels as a part of the embodiment may be made from paper or from other printable material. The labels are made from different materials, in different sizes, colors and shapes. Choosing the right label depends of the requirements from the customer. The company that creates designs may print the desired design on the outer side of the label. Inner side of the label has sticky material on it, where after placing the labels on the outer side of the beverage sleeves and/or cups, keeps the label and the beverage sleeves and/or cups as an adequate and functional unit. The inner side of the label, which has sticky material on it, is covered by paper material that is removed before placing the label on the outer side of the beverage sleeves and/or cups. The company that creates the design may send it to the customer using internet and web sites for sending adequately and functionally e-mail(s) to desired e-mail address or e-mail addresses, and/or regular mail, using fax, “Skype” program and/or other computer programs, hardware and software and/or any other way known in the prior art of delivering information, where customer may download it and print it on a labels and place the labels on the leftovers beverage sleeves and/or cups. In addition, the design company may place design on its website, where every customer may choose design, download it, print it on a label adequately and functionally using adequately and functionally connected hardware and software as is well known in the art of graphic design and printing industry. Also, the company that creates designs may log in, search and find the desired design, print the design on labels in a way known in an internet and print industry and deliver the printed labels using regular delivery method or delivery company.

Having described the principles of my invention, it should be apparent that these steps and elements of the invention are basic steps and elements and that more steps and elements may be added within the business method. From the foregoing, it will be appreciated that, although specific embodiments of the invention have been described herein for the purposes of illustration, various modifications may be made without deviating from the spirit and scope of the invention. Accordingly, I claim all steps, elements, and modifications as many come within the scope and spirit of the following claims.

I claim:

1. Method for providing dynamic visual information on beverage sleeves and/or cups comprising: company or companies that manufactures beverage sleeves and/or cups, daily collection of information collected by a person(s) and/or company or companies, person(s) and/or company or companies that created the design based on daily collected information, person(s) and/or company or companies that print the created design on an outer side of the beverage sleeves and/or cups daily or print the created design on the outer side of the labels daily, person(s) and/or company or companies that deliver the printed beverage sleeves and/or cups to the customers daily.

2. According the claim 1, wherein all components of the method are connected adequately and functionally together as a one successfully working unit, further comprising:
company or companies that manufacture beverage sleeves and/or cups cover a certain territory with its products, such as city, province, county, state and the like.
company or companies that produce beverage sleeves and/or cups send manufactured beverage sleeves and/or cups to the person(s) and/or company or companies that created the design, and/or to the person(s) and/or company or companies that print the created design on an outer side of the beverage sleeves and/or cups daily or print the created design on the outer side of the labels daily.
within the same territory may be created a design company, which is person(s) and/or company or companies that created the design based on daily collected information from that territory.
person(s) and/or company or companies that created the design based on daily collected information may also do print on the beverage sleeves and/or cups and/or labels using any available adequately and functionally connected together hardware and software, or send the design to the printing company and/or person(s) who will do the print job, using any known methods, technology, hardware and software for that.
person(s) and/or company or companies that print the created design on an outer side of the beverage sleeves and/or cups daily or print the created design on the outer side of the labels daily may be chosen by the location of the customers, by the customer's zip code, by their phone number and/or address or by any other way.
person(s) and/or company or companies that print the created design on an outer side of the beverage sleeves and/or cups daily or print the created design on the outer side of the labels daily receive successfully the design from person(s) and/or company or companies that created the design.
person(s) and/or company or companies that deliver the printed beverage sleeves and/or cups to the customers daily receive successfully the printed beverage sleeves and/or cups from the person(s) and/or company or companies that print the created design on an outer side of the beverage sleeves and/or cups daily or print the created design on the outer side of the labels daily, and deliver them to its customers.
this steps may be repeated and/or may be modified and are regulated by a business contract as is known in the business industry.

3. According the claim 1, wherein said daily collection of information includes daily or not daily collection of information that are based on survey(s) with relevant questions offered to the customers in order to know what kind of information they are interested to read and collected information are from different legal sources.

4. According the claim 1, wherein said daily collection of information includes daily or not daily collection of information that are collected by a beverage sleeves and/or cups manufacturing company, by person(s) and/or company or companies that create design, and/or other company or companies and/or person(s).

5. According the claim 1, wherein said daily collection of information includes daily or not daily collection of information that are collected on daily basis or not, selecting and choosing them according the needs of the customers from different legal sources, such as internet and websites, newspapers, TV, radio, magazines and other legal sources that may be used for collecting needed information and they may be collected based on a customer's zip code location and/or their phone number(s) for selecting and choosing adequate information for them.

6. According the claim 1, wherein said daily collection of information includes information that are provided by some source of information and everything is regulated with business contract as is known in the business industry according their needs.

7. According the claim 1, wherein said person(s) and/or company or companies that created the design includes person(s) and/or company or companies that created the design and the like, which may use adequately and functionally connected together working computer(s) and printer(s), which are an adequately and functionally connected together with other hardware and software in a way already known in a graphic design industry in order to create desired design.

8. According the claim 1, wherein said person(s) and/or company or companies that created design(s) includes person(s) and/or company or companies that creates design that may include, but not limited to, daily local weather report, daily comics, jokes, daily business and stock market information, daily local news, daily sport news, lottery report, health and sport information, warnings, emergency information, advertising, sales, and the like, photo or photos, graphics, number or numbers, letter or letters, color or colors, sign or signs, symbol or symbols, logo or logos, phone number or phone numbers, address or addresses, website address or website addresses, e-mail address or e-mail addresses, any language and/or any combination of them.

9. According the claim 1, wherein said person(s) and/or company or companies that created design(s) includes person(s) and/or company or companies that may have a business relation with a local print shop or not, where they send the design to be printed on beverage sleeves and/or cups using well-known methods and techniques known in printing industry and is regulated by business contract(s) in a way that is known in a business industry.

10. According the claim 1, wherein said person(s) and/or company or companies that created design(s) includes person(s) and/or company or companies that created design, where created design may be send to the print shop using any delivery method, including, but not limited to, using internet and websites for sending adequately and functionally e-mail(s) to desired e-mail address or e-mail addresses, and/or regular mail, using fax, “Skype” program and/or other computer programs, hardware and software and/or any other way known in the prior art of delivering information.

11. According the claim 1, wherein said person(s) and/or company or companies that print the created design on a beverage sleeves and/or cups daily includes person(s) and/or company or companies that prints the desired design on the outer side of the beverage sleeves and/or cups and/or labels and they may be located locally to the customers or not.

12. According the claim 1, wherein said person(s) and/or company or companies that print the created design on a beverage sleeves and/or cups daily includes person(s) and/or company or companies that may print the design on the beverage sleeves and/or cups daily, anytime of the day or night according the needs, including but not limited to, using an offset print techniques, stamping stamp and/or screen printing techniques, or any other method of printing and stamping known in printing industry.

13. According the claim 1, wherein said person(s) and/or company or companies that print the created design on a beverage sleeves and/or cups daily includes person(s) and/or company or companies that may print the design on a labels using any know techniques, hardware and software in the printing industry, using hardware and software connected adequately and functionally in a way already known in the computer industry and printing industry that makes printing design on a labels.

14. According the claim 1, wherein said person(s) and/or company or companies that print the created design on a beverage sleeves and/or cups daily includes person(s) and/or company or companies that prints the new designed information on the outer side of the labels, where printed labels may be placed over the old designed information already printed on the outer side of the beverage sleeves and/or cups.

15. According the claim 1, wherein said person(s) and/or company or companies that deliver the printed beverage sleeves and/or cups to the customers daily includes person(s) and/or companies that delivers printed beverage sleeves and/or cups or the printed labels that prepare beverage sleeves and/or cups and/or labels for shipping and deliver them to the customers that order them, by person or by a delivering company using any method known in the delivery industry.

16. According the claim 1, wherein said person(s) and/or company or companies that deliver the printed beverage sleeves and/or cups to the customers daily includes person(s) and/or company or companies that deliver the beverage sleeves and/or cups in a ways that are already known in the of delivery industry.

17. According the claim 1, wherein said person(s) and/or company or companies that created the design includes person(s) and/or company or companies that creates the design that may be send it to its customer using internet, website(s) for sending adequately and functionally e-mail(s) to desired e-mail address or e-mail addresses, and/or regular mail, using fax, “Skype” program and/or other computer programs, hardware and software and/or any other way known in the art of delivering information, where customer may download it, redesign it, print it on an outer side of the labels, and place the printed labels on the outer side of the beverage sleeves and/or cups.

18. According the claim 1, wherein said person(s) and/or company or companies that created the design includes person(s) and/or company or companies that may place design on its website where every customer may use it, log in to the website, search and choose different design(s), download them, print them on a label adequately and functionally using adequately and functionally connected hardware and software as is well known in the art of graphic design, printing industry and internet and website industry.

19. According the claim 1, wherein said person(s) and/or company or companies that deliver the printed beverage sleeves and/or cups to the customers daily includes person(s) and/or company or companies that, print the labels for its customers and send printed labels to its customers using method known in the delivery industry.

20. According the claim 1, wherein said labels includes labels where:
labels may be made from paper or from other printable material made from different materials, in different sizes, colors and shapes in a way already known in a label industry;
labels that has sticky material on it inner side, where after placing the labels with its inner side on the outer side of the beverage sleeves and/or cups, keeps the label and the beverage sleeves and/or cups as one adequate and functional unit and labels that are manufactured adequately and functionally as is known in the labels industry;
labels may be printed by a person(s) and/or company or companies that create design, by a person(s) and/or company or companies that print the design, or by any other person(s) and/or company or companies.
